(19) United States
(12) Patent Application Publication
(10) Pub. No.: US 2002/0094142 A1
(43) Pub. Date: Jul. 18, 2002

(54) Pivot bearing

(75) Inventors: Richard A. Knepper, Keene, NH (US); Keith M. Gordon, Munsonville, NH (US)

Correspondence Address: POLSTER, LIEDER, WOODRUFF & LUCCHESI, 763 SOUTH NEW BALLAS ROAD, ST. LOUIS, MO, 63141-8750, US

(73) Assignee: The Timken Company

(21) Appl. No.: 09/760,688

(22) Filed: Jan. 16, 2001

(51) Int. Cl. F16C 17/04

(52) U.S. Cl. 384/245

(57) ABSTRACT

A bearing, which may be used to mount a swing arm on the frame of a computer disk drive, has an outer race provided with two raceways of arcuate cross section. Each raceway has a row of raceway balls located along it. The raceway balls of each row, in turn, surround and bear against a separate pivot ball. The two pivot balls are greater in diameter than the circles described by the innermost areas of the rows of raceway balls, so that the pivot balls when urged together bear against the raceway balls of the two rows and urge them against their raceways. The force which urges the two pivot balls together may derive from spring-loaded arm engaged with one of the balls.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

This invention relates in general to antifriction bearings, and more particularly, to antifriction bearings capable of accommodating pivoting and rotation.

Within the hard disk drive of the typical electronic computer, a swing arm moves back and forth over a rotating disk, which carries information in a magnetic format, and in so doing the swing arm changes the position of a magnetic read-write head over the disk. In this way the read-write head may extract information from or transfer information to tracks on the rotating disk. The arm, which is positioned by an electrical actuating mechanism, must operate with considerable precision. If the arm does not operate precisely, the read-write head will deviate from the track it is to follow or scrape and damage the disk. Hence, the swing arm, although free to pivot about its axis, must otherwise remain rigid. The bearings which support the arm must not allow the arm to wobble or, indeed, move in any direction other than rotate about its own pivot axis.

In the conventional disk drive of current manufacture the swing arm pivots about a spindle on two single row ball bearings. Each bearing has inner and outer races provided with opposing raceway and balls between the raceways. They are relatively expensive to manufacture and introduce complexities into the assembly of disk drives of which they are a part.

### SUMMARY OF THE INVENTION

The present invention resides in a bearing having an outer race provided with raceways that are presented inwardly toward the axis of the bearing. Rolling elements are arranged in circular rows along the raceways, there being a separate row for each raceway. The rolling elements in turn surround pivot elements which, when urged together, urge the rolling elements against their respective raceways. The invention also resides in a computer disk drive having a frame and a swing arm coupled to the frame by the bearing.

### DESCRIPTION OF THE DRAWINGS

FIG. 1 is a perspective view of a disk drive having its swing arm coupled to its frame with a bearing constructed in accordance with and embodying the present invention;

FIG. 2 is a sectional view of the swing arm and frame where the two are coupled by the bearing;

FIG. 3 is a sectional view of the bearing;

FIG. 4 is a sectional view of the bearing taken along lines 4-4 of FIG. 3; and

FIG. 5 is a sectional view of a modified bearing.

### DETAILED DESCRIPTION

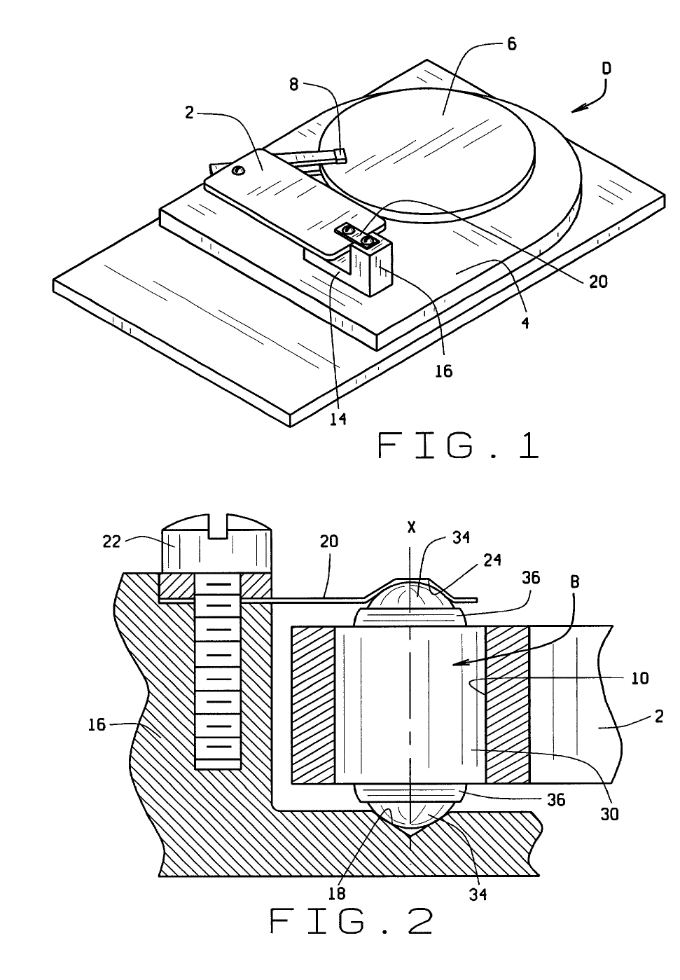

Referring now to the drawings, a bearing B (FIG. 2) in a broad sense enables one member to rotate relative to another member about an axis X, with the substantial absence of wobble or free motion in the axial and radial directions. The rotation may be incremental or continuous and likewise may be in one direction about the axis X or both. Typically, the bearing B finds utility in the disk drive D (FIG. 1) of an electronic computer where the one member is a swing arm 2, whereas the other member is a frame 4 which supports the swing arm 2 as well as a rotating disk 6 on which information in a magnetic format is stored. Here the swing arm 2 undergoes pivotal movement, in the form of incremental rotation in both directions, clockwise and counter-clockwise. The swing arm 2 at its one end carries a magnetic head 8 and at its other end has a bore 10 which contains the bearing B. As the arm 2 pivots about the axis X on the bearing B, the magnetic head 8 moves over the surface of a rotating disk 6, yet with a slight clearance between the head and the surface of the disk 6. Actually, the arm 2 is connected to an actuator which effects the pivotal movement.

The frame 4 includes (FIG. 2) a base 14 and a pedestal 16 which rises from the base 14. The end of the swing arm 2 which contains the bearing B resides over the base 14 and adjacent to the pedestal 16. In the present embodiment, the base 14 is provided with a conical depression 18, though the depression 18 may alternatively be spherical. The axis of the depression 18 coincides with the axis X. The pedestal 16 supports a retaining arm 20 which, at one end, is fastened securely to the pedestal 16 with a machine screw 22. The arm 20 projects from pedestal 16 over that end of the swing arm 2 that contains the bearing B, and here the retaining arm 20 is provided with a conical depression 24 which may alternatively be spherical and which opens toward the depression 18 in the base 14, with the axis of the depression 24 likewise coinciding with the pivot axis X. The retaining arm 20 is formed from a flexible and resilient material, preferably spring steel.

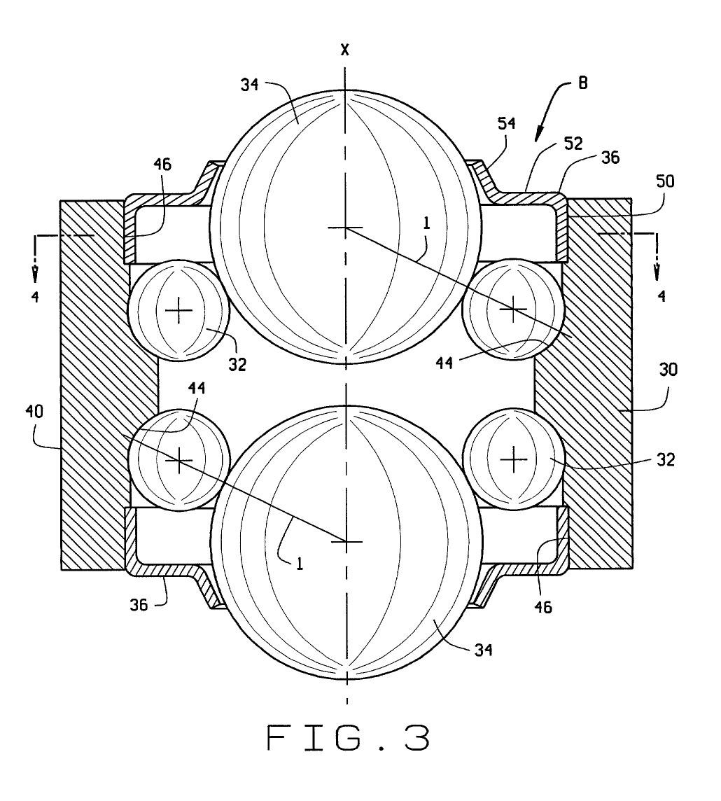

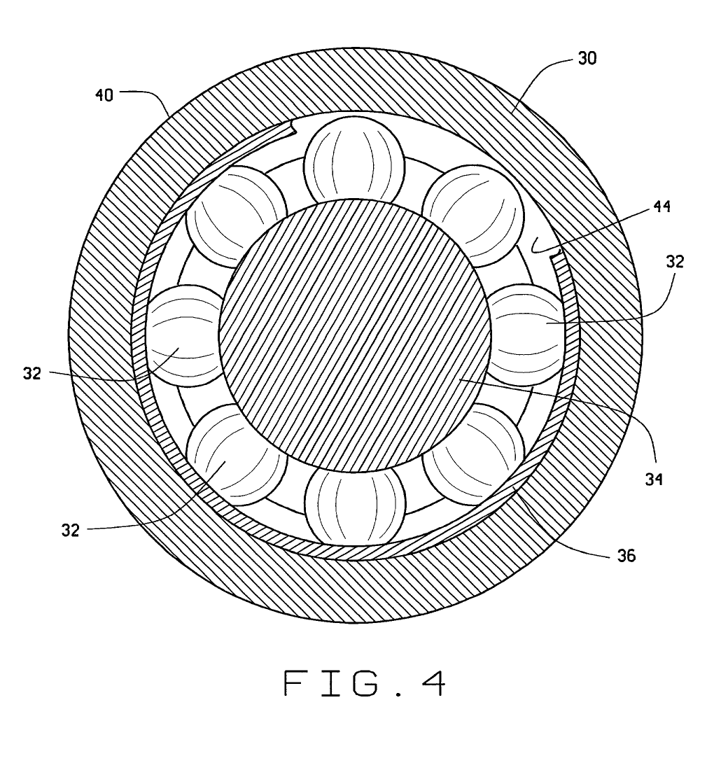

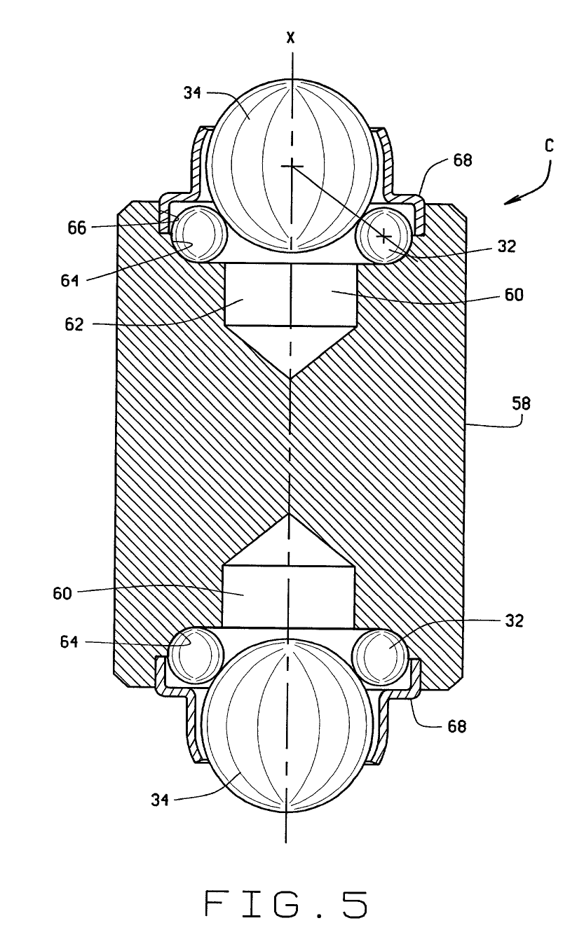

The bearing B fits into the bore 10 in the end of the swing arm 2 and is further captured between the base 14 and retaining arm 20 of the frame 4 at the depressions 18 and 24. The bearing B includes (FIGS. 3 & 4) an outer race 30, raceway rolling elements or balls 32 located in two circular rows within the race 30, pivot elements or balls 34 located within the rows of raceway balls 32, there being one for each row, and retainers 36 for maintaining the pivot balls 34 and raceways balls 32 within the outer race 30 when the bearing B is removed from the frame 4. These retainers 36 further act to shield the internal parts from external contamination which would otherwise cause deterioration and problems in performance.

The outer race 30, which is preferably formed from a bearing steel, has a cylindrical exterior surface 40, the diameter of which is slightly larger than the diameter of the bore 10 in the end of the swing arm 2. Hence, an interference fit exists at the surface of the bore 10 and the exterior surface 40 of the race 30, and the race 30 must be pressed into the bore 10. The race 30 may have a flange at one end of its cylindrical surface 40 to locate it axially in the bore 10 of the swing arm 2. On its interior the race 30 has two raceways 44 which are presented toward the axis X, and while they are spaced axially apart, they share the axis X and are thus concentric. Moreover, the raceways 44 are oblique to the axis X in the sense that their ends that are located closest to the mid-region of the race 30 are closer to the axis X than their end that are remote from the mid-region. In other words, each raceway 44 has small and large diameter ends, with the small diameter ends for the two raceways 44 being closer together than the large ends. Actually, the raceways 44 are arcuate in cross-section, and their contour conforms generally to the contour of the raceway balls 32. They are preferably hardened, such as by case-carburizing, and are finished by grinding. The raceways 44 at their large ends open into end bores 46 of slightly greater diameter, and the end bores 46 in turn open out of the ends of the race 30. The raceways 44 and the end bores 46 are all concentric, with their common center being the axis X.

The raceway balls 32 lie along the raceways 44, forming a separate row along each raceway 44. Within any row the balls 32 are of equal radius, and that radius should not exceed the cross-sectional radius of the raceway 44 along which the row is located. The balls 32 are preferably formed from bearing steel and hardened.

The pivot balls 34 fit generally into the rows of raceway balls 32, their being a separate pivot ball 34 for each row of raceway balls 32. However, the diameter of each pivot ball 34 exceeds the diameter of the circle described by the innermost surface areas of the raceway balls 32. As a consequence, neither pivot ball 34 will pass axially through the row of raceway balls 32 with which it is identified, but instead seats against the array of balls 32 that form the row. As a consequence, each pivot ball 34 contacts each raceway ball 32 of the row with which it identified along a line 1 (FIG. 3) that passes through the center of the pivot ball 34 and the center of the raceway ball 32 and lies oblique to the axis X.

The retainers 36 fit into the end bores 46 of the outer race 30 and keep the pivot balls 34 from moving axially out of the race 30. The pivot balls 34 in turn maintain the raceways balls 32 organized in rows along the raceways 44, that is to say they keep the raceway balls 32 in place along the raceways 44. Each retainer 36 (FIG. 3) has an axially directed portion 50 that is pressed into the end bore 46 at one end of the outer race 30, a radially directed portion 52 that extends inwardly toward the pivot ball 34 at that end of the outer race 30, and a beveled portion 54 surrounding the pivot ball 34 axially beyond the center of the pivot ball 34. The beveled portion 54 generally follows the contour of the pivot ball 34 and is annular, thus leaving some of the pivot ball 34 exposed beyond the end of the outer race 30. The two pivot balls 34 are spaced apart within the outer race 30, and the spacing between the endmost regions of the two pivot balls 34, that is the regions which are beyond the retainers 36 and along the axis X, exceeds the spacing between the base 14 and retaining arm 20 at the depressions 18 and 24 in those respective components of the frame 4 when the retaining arm 20 is undeflected.

The bearing B, with the swing arm 2 projected from it, fits between the base 14 and the retaining arm 20 of the frame 4 with the pivot balls 34 received in the depression 18 of the base 14 and the depression 24 of the retaining arm 20. Indeed, the resilient retaining arm 20 deflects elastically when the bearing B is fitted between it and the base 14, and remains deflected when the bearing B is in place. Thus, the retaining arm 20 urges the two pivot balls 34 together, and the pivot balls 34 in turn urge their raceway balls 34 against the raceways 44 on the outer race 30. In other words, the retaining arm 20, owing to the spring bias that it provides, preloads the bearing B and thus eliminates internal clearances, both radial and axial, from the bearing B.

In use, the bearing B couples the swing arm 2 with the frame 4, so that the frame 4 can support the swing arm 2 with the magnetic head 8 on the swing arm 2 located over the rotating disk 6 that is also on the frame 4. Since the pivot balls 34 are received in the depressions 18 and 24 of the base 14 and retaining arm 20 of the frame 4, the bearing B cannot be displaced radially or axially with respect to the axis X. Furthermore, since the retaining arm 20 urges the two pivot balls 34 together and the lines of contact 1 between the pivot balls 34, the raceway balls 32 and the raceway 44 are oblique to the axes X, the raceway balls 32 are compressed between the pivot balls 34 and the raceways 44, and this eliminates both radial and axial clearances within the bearing B. Thus, the outer race 30 cannot be displaced either radially or axially with respect to the axis X and frame 2, and the same hold true with respect to the swing arm 2. Nevertheless, the outer race 30 and swing arm 2 can rotate easily with respect to frame 4 about the axis X. When rotation occurs, the raceway balls 32 of the two rows roll along their respective raceways 44 and also roll along the spherical surfaces of their respective pivot balls 34. Little friction exists along the regions of contact between the raceway balls 32, on one hand, and the raceways 30 and pivot balls 34, on the other, and the rotation is produced with minimal torque.

A modified bearing C (FIG. 5) likewise has raceway balls 32 arranged in two rows and a pivot ball 34 for each row, with each pivot ball 34 contacting each of its raceway balls 32 along a line 1 that lies oblique to the axis X. In addition, the modified bearing C has an outer race 58 having a cavity 60 opening out of each of its ends. Each cavity 60 is configured to form a central portion 62, a raceway 64 into which the central portion 62 opens, and an end bore 66 located beyond the raceway 64. The raceway 64 is arcuate in cross section and conforms generally to the contour of the raceway balls 32. The end bore 66 opens out of the end of the race 58 and receives a retainer 68 that extends over the raceway balls 32, but only over part of the pivot ball 34. Nevertheless, the pivot ball 34 projects through the retainer to contact the raceway balls 32.

The pivot balls 34 fit into the depressions 18 and 24 in the base 14 and retaining arm 20, respectively, and the force exerted by the retaining arm 20 holds the pivot balls 34 against the raceway balls 32 of their respective rows. However, the retainers 68 do keep the pivot balls 34 within the remainder of the bearing C when the bearing C is withdrawn from the frame 4.

When the bearing B or C supports the swing arm 2 on the frame 4, the raceway balls 32 may have a diameter on the order of 0.0938 in., whereas the pivot balls 34 may have a diameter ranging between 1/16 inch and ½ inch.

The outer races 30 or 58 may be formed integral with the swing arm 2.

What is claimed is:

1. A bearing for accommodating rotation about an axis, said bearing comprising: an outer race having first and second raceways spaced axially apart and presented generally toward the axis, each raceway having a contact area that is oblique to the axis, with the contact area of the first raceway being inclined opposite to the contact area for the second raceway; raceway rolling elements arranged in first and second circular rows along the first and second raceways, respectively, and contacting the raceways at the contact areas of the raceways, a first pivot element having a contact surface along which it contacts the raceway rolling elements of the first row and urges them toward the first raceway; and a second pivot element having a contact surface along which it contacts the raceway elements of the second row and urges them toward the second raceway.

2. A bearing according to claim 1 wherein the contact surface of the first pivot element is a convex spherical contact surface, and wherein the contact surface of the second pivot element is a convex spherical contact surface.

3. A bearing according to claim 2 wherein the raceway rolling elements are spherical.

4. A bearing according to claim 3 wherein the pivot elements are spherical substantially in their entireties.

5. A bearing according to claim 1 wherein the first and second raceways are inclined such that their contact areas are presented generally away from each other, whereby, when the pivot elements are urged together, they urge the rolling elements of the first and second rows against the first and second raceways.

6. A bearing according to claim 5 and further comprising retainers fitted to the outer race and encircling the first and second pivot elements to prevent the pivot elements from withdrawing axially from the raceway rolling elements of the first and second rows.

7. A bearing according to claim 6 wherein the pivot elements are exposed through the retainers.

8. A bearing for accommodating rotation about an axis, said bearing comprising: an outer race having first and second raceways which are presented inwardly toward the axis, the raceways being arcuate in cross section and inclined such that the first raceway slopes outwardly toward one end of the outer race and the second raceway slopes outwardly toward the other end of the outer race; first raceway balls arranged in a circular row along the first raceway of the outer race; second raceway balls arranged in a circular row along the second raceway of the outer race; a first pivot element contacting the first raceway balls and urging the first raceway balls against the first raceways; and a second pivot element contacting the second raceway balls so as to urge the second raceway balls against the second raceway.

9. A bearing according to claim 8 wherein the first pivot element is convex in configuration in its region of contact with the first raceway balls, and wherein the second pivot element is convex in configuration in its region of contact with the second raceway balls.

10. A bearing according to claim 9 wherein the convex region of the first pivot element is spherical and has a radius greater than the radius of the circle described by the innermost surface areas of the first raceway balls; and wherein the convex region of the second pivot element is spherical and has a radius greater than the radius of the circle described by the innermost surface areas of the second raceway balls.

11. A bearing according to claim 10 wherein the first and second pivot elements are spaced axially from each other within the outer race.

12. A bearing according to claim 11 and further comprising a first retainer fitted to the outer race and overlying to first pivot element such that first pivot element cannot be withdrawn axially from the first raceway balls, and a second retainer fitted to the outer race and overlying the second pivot element such that the second pivot element cannot be withdrawn axially from the second raceway balls.

13. A bearing according to claim 12 wherein the first and second retainers are annular in configuration, and the first and second pivot elements are exposed through the first and second retainers, respectively.

14. A bearing according to claim 11 wherein the first and second pivot elements are spherical in their entireties.

15. In combination with the bearing of claim 8, a base having a first depression in which the first pivot element is received and a retaining arm having a second depression in which the second pivot element is received; and wherein the retaining arm is biased toward the base to urge the first and second retaining elements together, whereby the first raceway balls are compressed between the first pivot element and the first raceway and the second raceway balls are compressed between the second pivot element and the second raceway.

16. The combination according to claim 15 and further comprising a swing arm having one end fitted to the outer race of the bearing and carrying a magnetic head at its other end.

17. In a disk drive for an electronic computer, the combination comprising: a frame having a base and a spring-loaded arm spaced from the base; a first pivot element engaged with the base and having a spherical surface presented away from the base; a second pivot element engaged with the arm and carrying a spherical surface presented generally toward the spherical surface on the first pivot element; the spherical surfaces of the first and second pivot elements having centers which define an axis; a swing arm having one end located around the axis and having a magnetic hand at its other end; first and second raceways carried by the swing arm and surrounding the axis, the first raceway being presented toward the spherical surface on the first pivot element and the second raceway being presented toward the spherical surface on the second pivot element; first raceway balls located in a circular row along the first raceway and being compressed between the spherical surface on the first pivot element and the first raceway; and second raceway balls located in a circular row along the second raceway and being compressed between the spherical surface of the second pivot element and the second raceway.

18. The combination according to claim 17 wherein the raceways are arcuate and inclined outwardly away from each other such that they have their least diameters where they are closest to each other.

19. The combination according to claim 18 wherein the base has a recess in which the first pivot element is received, and the retaining arm has a recess in which the second pivot element is received.

20. The combination according to claim 19 wherein first and second pivot elements are spherical substantially in their entireties.

21. The combination according to claim 18 wherein the retaining arm has one end mounted in a fixed position with respect to the base and its other end is engaged with the second pivot element; and wherein the arm is resilient and deflected so that it urges the second pivot element toward the first pivot element.
